(19) United States
(12) Patent Application Publication
(10) Pub. No.: US 2013/0157591 A1
(43) Pub. Date: Jun. 20, 2013

(54) RF Transceiver

(71) Applicants: Chi-Ho Chang, New Taipei City (TW); Jui-Chi Huang, Penghu County (TW); Jau-Chen Chen, Taoyuan County (TW); Kuei-Ju Lee, New Taipei City (TW); Chi-Hua Tseng, New Taipei City (TW)

(72) Inventors: Chi-Ho Chang, New Taipei City (TW); Jui-Chi Huang, Penghu County (TW); Jau-Chen Chen, Taoyuan County (TW); Kuei-Ju Lee, New Taipei City (TW); Chi-Hua Tseng, New Taipei City (TW)

(73) Assignee: Chung-Shan Institute of Science and Technology, Armaments, Bureau, Ministry of National Defense, Taoyuan County (TW)

(21) Appl. No.: 13/437,186

(22) Filed: Apr. 2, 2012

(30) Foreign Application Priority Data
Dec. 20, 2011 (TW) 100147282

(51) Int. Cl. H04B 1/44

(52) U.S. Cl. 455/78

(57) ABSTRACT

A signal generation and transmission system includes a modulator and an RF transceiver. The RF transceiver includes a voltage-controlled oscillator, a power divider, a low-pass filter, a low-noise amplifier and a mixer. The voltage-controlled oscillator receives a signal from the modulator and produces a frequency modulated continuous wave signal. The power divider receives the frequency modulated continuous wave signal from the voltage-controlled oscillator. The low-pass filter receives the frequency modulated continuous wave signal from the power divider. The low-noise amplifier receives, amplifies and transfers a target echo signal. The mixer combines the frequency modulated continuous wave signal from the power divider with the echo signal of target from the low-noise amplifier so that the two signals are added up or subtracted from each other in a frequency band.

### BACKGROUND OF INVENTION

1. Field of Invention

The present invention relates to a microwave RF circuit and analog electronic circuit and, more particularly, to a RF transceiver for reducing noises.

2. Related Prior Art

A conventional RF transceiver includes an antenna, an RF filter, a two-way switch, a receiver and a transmitter. The two-way switch connects the antenna to the receiver or transmitter. The RF transceiver converts signal to an RF from a baseband. The frequency range of the baseband is about DC to tens of MHz. The frequency range of the RF is in the order of a GHz.

To avoid a signal from interfering with another, conversion of the RF to the baseband signal and the conversion of the baseband signal to the RF are done at a single mixing step. Thus, the RF is amplified in the receiver. A mixer mixes the RF signal with a local oscillation signal to provide a converted signal that includes a baseband component. However, cavity mode interference must be taken into consideration in the use of the conventional RF transceiver. To avoid cavity mode interference, isolation chambers are used to isolate a voltage-controlled oscillator, the mixer, the receiver and the transmitter from one another to avoid them from interfering with one another. However, the isolation chambers entail a bulky shell to contain the RF transceiver.

The present invention is therefore intended to obviate or at least alleviate the problems encountered in prior art.

### SUMMARY OF INVENTION

It is an objective of the present invention to provide a RF transceiver for converting a microwave or RF signal to a baseband signal via a mixer in a zero-IF conversion.

It is another objective of the present invention to provide a RF transceiver for reducing coupling of adjacent microstrip lines to each other and radiation leakage from these lines in an impedance-matching manner by software according to the electromagnetic field theory.

It is another objective of the present invention to provide a RF transceiver for avoiding power loss and radiation leakage in transmission of data with a low-consumption circuit board and efficient microwave elements.

To achieve the foregoing objectives, the RF transceiver includes a voltage-controlled oscillator, a power divider, a low-pass filter, a low-noise amplifier and a mixer. The voltage-controlled oscillator receives a signal from the modulator and accordingly generates a frequency modulated continuous wave signal. The power divider receives the frequency modulated continuous wave signal from the voltage-controlled oscillator. The low-pass filter receives the frequency modulated continuous wave signal from the power divider, reduces high order harmonic frequency signals, enhances pass-band frequency signals, and transmits the dominant frequency signal within the pass-band to an RF antenna. The low-noise amplifier receives, amplifies and transfers an echo signal of target. The mixer combines the continuous oscillation frequency signal from the power divider with the echo signal of target from the low-noise amplifier so that the two signals are added up or subtracted from each other in a frequency band.

Other objectives, advantages and features of the present invention will be apparent from the following description referring to the attached drawings.

### BRIEF DESCRIPTION OF DRAWINGS

The present invention will be described via detailed illustration of two embodiments referring to the drawings wherein:

FIG. 1 is a block diagram of an RF transceiver according to the first embodiment of the present invention; and

FIG. 2 is a flow chart of a method for reducing noises in an RF transceiver according to the second embodiment of the present invention.

### DETAILED DESCRIPTION OF PREFERRED EMBODIMENT

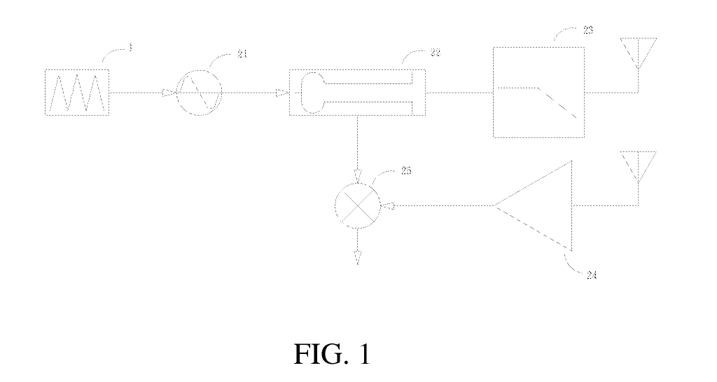

Referring to FIG. 1, there is shown an RF transceiver for use in a signal generation and transmission system according to the preferred embodiment of the present invention. The signal generation and transmission system includes a modulator 1 for controlling a voltage.

The RF transceiver includes a voltage-controlled oscillator 21, a power divider 22, a low-pass filter 23, a low-noise amplifier 24 and a mixer 25. The voltage-controlled oscillator 21 is connected to the modulator 1. The voltage-controlled oscillator 21 is used to receive a signal from the modulator 1 and produce a frequency modulated continuous wave signal accordingly.

The power divider 22 is connected to the low-pass filter 23 at an output end and connected to the mixer 25 at another output end. Based on different impedances at the output ends, the power divider 22 sends the frequency modulated continuous wave signal to the low-pass filter 23 and to a local oscillation end of the mixer 25. The power divider 22 is preferably a 1:1 power divider. The power divider 22 includes a first signal end, a second signal end and a third signal end. The first signal end of the power divider 22 is connected to the voltage-controlled oscillator 21. The second end of the power divider 22 is connected to an antenna for example. The third signal end of the power divider is connected to the mixer 25.

The low-pass filter 23 is used to receive the frequency modulated continuous wave signal. The low-pass filter 23 reduces high order harmonic frequency signals, i.e., a portion of the signal higher a stop-band of the low-pass filter. Moreover, the low-pass filter 23 enhances the dominant signal within the low-pass filter, i.e., a portion of the signal within pass-band of the low-pass filter. Then, the low-pass filter 23 transmits the frequency modulated continuous wave signal within the pass-band to an RF antenna for example.

The low-noise amplifier 24 is used to receive an echo signal of target from another antenna for example, amplify and transmit the echo signal of target.

The mixer 25 is used to receive the frequency modulated continuous wave signal via the local oscillation end. The mixer 25 combines the frequency modulated continuous wave signal from the power divider 22 with the echo signal of target from the low-noise amplifier 24. Thus, the two signals are added up or subtracted from each other in a frequency band.

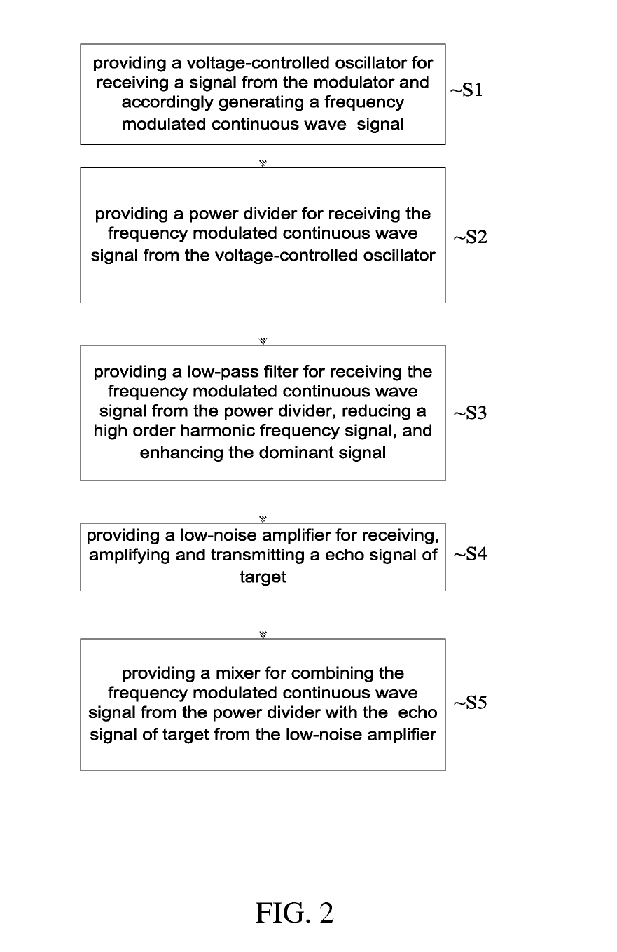

Referring to FIG. 2, there is shown a method for reducing noises in an RF transceiver for use in a signal generation and transmission system according to a second embodiment of the present invention. The signal generation and transmission system includes a modulator 1.

The RF transceiver includes a voltage-controlled oscillator 21, a power divider 22, a low-pass filter 23, a low-noise amplifier 24 and a mixer 25. The voltage-controlled oscillator 21 is connected to the modulator 1. The power divider 22 is connected to the low-pass filter 23 at an output end and connected to the mixer 25 at another output end. The low-noise amplifier 24 is connected to the mixer 25.

At S1, the voltage-controlled oscillator 21 receives a linear signal from the modulator 1 and modulates the single tone continuous wave signal to a frequency modulated continuous wave signal.

At S2, the power divider 22 receives the frequency modulated continuous wave signal from the voltage-controlled oscillator 21. Based on different impedances at two output ends, the power divider 22 transmits the frequency modulated continuous wave signal to the low-pass filter 23 at an output end and to a local oscillation end of the mixer 25 at the other output end. Impedance matching is done in a Smith chart according to the different impedances at the output ends of the power divider 22, thus minimizing signal-transmission loss.

At S3, the low-pass filter 23 receives the frequency modulated continuous wave signal from the power divider 22. The low-pass filter 23 reduces high order harmonic frequency signals, i.e., a portion of the signal higher a stop-band of the low-pass filter. Thus, the low-pass filter 23 enhances the dominant signal within the low-pass filter, i.e., a portion of the signal within pass-band of the low-pass filter. Then, the low-pass filter 23 transmits the frequency modulated continuous wave signal within the pass-band to an RF antenna for example. The low-pass filter 23 is designed by the microstrip mode.

At S4, the low-noise amplifier 24 receives an echo signal of target from another RF antenna, and amplifies and transfers the echo signal of target.

At S5, because of the microstrip-line impedance matching of the mixer 25 with the low-noise amplifier 24 and of the mixer 25 with the low-pass power divider 22, the mixer 25 receives the frequency modulated continuous wave signal via the local oscillation end. The mixer 25 combines the frequency modulated continuous wave signal from the power divider 22 with the echo signal of target from the low-noise amplifier 24. Thus, the signals are added up or subtracted from each other in a frequency band. The microstrip-line impedance matching is executed with an L-type and F-type matching elements or a ¼ wavelength matching element.

The present invention has been described via the detailed illustration of the embodiments. Those skilled in the art can derive variations from the embodiments without departing from the scope of the present invention. Therefore, the embodiments shall not limit the scope of the present invention defined in the claims.

1. An RF transceiver for use in a signal generation and transmission system that includes a modulator 1 for controlling a voltage, wherein the RF transceiver includes:
a voltage-controlled oscillator 21 for receiving a signal from the modulator 1 and accordingly producing a continuous oscillation frequency signal;
a power divider 22 for receiving the frequency modulated continuous wave signal from the voltage-controlled oscillator 21;
a low-pass filter 23 for receiving the frequency modulated continuous wave signal from the power divider 22, reducing high order harmonic frequency signals, enhancing the dominant signal within the low-pass filter, and transmitting the frequency modulated continuous wave signal within the pass-band to an RF transmitting end;
a low-noise amplifier 24 for receiving, amplifying and transmitting an echo signal of target; and
a mixer 25 for receiving the frequency modulated continuous wave signal from the power divider 22 and the echo signal of target from the low-noise amplifier 24 and combining the two signals with each other so that the two signals are added up or subtracted from each other in a frequency band.

2. The RF transceiver according to claim 1, wherein the power divider 22 is 1:1 power divider.

3. The RF transceiver according to claim 1, wherein the power divider 22 includes a first signal end, a second signal end and a third signal end.

4. The RF transceiver according to claim 3, wherein the first signal end of the power divider 22 is connected to the voltage-controlled oscillator 21.

5. The RF transceiver according to claim 3, wherein the second end of the power divider 22 is connected to an antenna.

6. The RF transceiver according to claim 3, wherein the third signal end of the power divider 22 is connected to the mixer 25.

7. A method for reducing noises in an RF transmitter for use in a signal generation and transmission system that includes a modulator 1, wherein the method includes the steps of:
providing a voltage-controlled oscillator 21 for receiving a signal from the modulator 1 and accordingly producing a frequency modulated continuous wave signal;
providing a power divider 22 for receiving the frequency modulated continuous wave signal from the voltage-controlled oscillator 21;
providing a low-pass filter 23 for receiving the frequency modulated continuous wave signal from the power divider 22, reducing high order harmonic frequency signals, enhancing the dominant signal within the low-pass filter, and transmitting the frequency modulated continuous wave signal within the pass-band to an RF antenna, wherein the low-pass filter 23 is designed by the microstrip mode;
providing a low-noise amplifier 24 for receiving, amplifying and transmitting a target echo signal; and
providing a mixer 25 for combining the frequency modulated continuous wave signal from the power divider 22 with the echo signal of target from the low-noise amplifier 24 so that the two signals are added up or subtracted from each other in a frequency band, wherein the microstrip-line impedance matching is executed with L-type and F-type matching elements or a ¼ wavelength matching element.

8. The RF transceiver according to claim 7, wherein the power divider 22 is 1:1 power divider.

9. The RF transceiver according to claim 7, wherein the power divider 22 includes a first signal end, a second signal end and a third signal end.

10. The RF transceiver according to claim 9, wherein the first signal end of the power divider 22 is connected to the voltage-controlled oscillator 21.

11. The RF transceiver according to claim 9, wherein the second end of the power divider 22 is connected to an antenna.

12. The RF transceiver according to claim 9, wherein the third signal end of the power divider 22 is connected to the mixer 25.
